(19) United States
(12) Patent Application Publication
(10) Pub. No.: US 2001/0037282 A1
(43) Pub. Date: Nov. 1, 2001

(54) Method for trading a manufacturing capacity and manufacturing capacity trading system

(76) Inventor: Hideki Yoneda, Tokyo (JP)

Correspondence Address: GREENBLUM & BERNSTEIN, P.L.C., 1941 ROLAND CLARKE PLACE, RESTON, VA, 20191, US

(21) Appl. No.: 09/810,475

(22) Filed: Mar. 19, 2001

(30) Foreign Application Priority Data
Mar. 31, 2000 (JP) 2000-098297

(51) Int. Cl. G06F 17/60

(52) U.S. Cl. 705/37

(57) ABSTRACT

The invention provides means to enable stable operation rates of the industries which needs huge facilities.

The traders access to the server computer systems of trading service sites. The systems display input screens on the trades computer display devices. The traders input code information related to the manufacturing capacities, information of selling or buying, bidding prices, size information of manufacturing capacities to be traded, and periodic information of manufacturing capacities to be traded. The traders send these input information to the systems. The sent information is recorded as the transaction (bid) information in the trade information files of the systems. The systems make each trade by searching and judging the trade information files by referring code information among trade information to match conditions such as buying or selling, bidding prices, and periodic information.

### FIELD OF THE INVENTION

The present invention relates to manufacturing capacity trades and trading systems. Especially, the present invention relates to useful technologies which trade manufacturing capacities categorized by attributes like semiconductor manufacturing process and design rules by which products are manufactured.

### BACKGROUND OF THE INVENTION

Various electronic trades are prosperously done, as recent computer network development. Financial product trades using the Internet are one of most successful examples. Another example is the trades of truck transportation capacities on the site on computer networks.

However, manufacturing capacities in semiconductor industry heavily depend on semiconductor manufacturing machines and process technologies, therefore each company has its own different process technology and know-how. For example, in the Bipolar device manufacturing process, there are epitaxial processes, where precise dopant diffusion control is needed. The manufacturing processes of memory devices (MOS transistors) like DRAMs which need reactive ion etching processes to achieve highly dense integration. Saliside and CMP technologies, used in multi-layer metal line processes, are needed in case that logic circuits, requiring fast functions, comprising CMOS transistors.

Thus, manufacturing capacity comprises various different technologies like photolithography, thin film formation technologies and so on, therefore, there are many types of process technologies exist. They are different each other and can not compare in terms of the number of wafers manufacturable per month. For example, the manufacturing facility made for bipolar devices can not be applied to CMOS process without major modification, and vice versa.

However, in semiconductor industry, co-working business formations, such that design process, manufacturing process and IP (Intellectual Property: the information and technologies which are necessary to design and manufacture products) development and supply are done by different companies, are developed in order to adapt fast technology development and avoidance of heavy risky investment. Therefor, the business formations in which product marketing and planning division, product design division, wafer mask production division, wafer process division, packaging division, test and reliability division are each different company and cooperate to produce a product, have become popular. On this premise, for example, as for manufacturing process, manufacturing facility standardization are needed to cover as many products as possible. Now, manufacturing facility standardization is undergoing in two or three groups. Most of semiconductor products will be able to be manufactured with this two or three standardized manufacturing facilities in the future.

As a outcome of this standardization, the companies, which concentrate resources into product planning and design, and outsource other wafer manufacturing and packaging process, are emerging. These kind of fabless semiconductor makers concentrate human and money resources into product planning and design, make their competence stronger by efficient management. On the other hand, foundries concentrate human and money resources into manufacturing facilities and process technologies necessary to manufacture products. Foundry (Here, the word foundry means the company or a division of a company which concentrate its business into manufacture of others' products) companies' main business is to manufacture fabless makers' products, but also they manufacture LSI products ordered by LSI user companies' LSI design divisions, by LSI design support service companies, and by LSI makers' LSI design divisions in some case.

Under this background, manufacturing outsourcing contracts are made individually between foundry companies and fables makers, LSI user companies' LSI design divisions, LSI design support service companies, and LSI makers' LSI design divisions. In general, long term fixed period contracts such as six months or one year contracts are made. Under this contracts, manufacturing outsourcers such as fables makers, LSI user companies' LSI design divisions, LSI design support service companies, and LSI makers' LSI design divisions, have merits that they can keep certain manufacturing capacities, but semiconductor products demand is not stable and unpredictable. For example, in general, in July the demand small so that a lot manufacturing capacities are left over, but in general, the demand is large in September so that manufacturing capacities are short to meet the demand.

Under this situation, if the left over manufacturing capacities are sold to other manufacturing outsourcers, the money invested will be collected effectively. On the other hand, in case that manufacturing capacities are short, if manufacturing outsourcers who is short of manufacturing capacities can buy manufacturing capacities from other foundry companies or other manufacturing outsourcers who have the left over right to use manufacturing capacities, the manufacturing outsourcers who is short of manufacturing capacities can avoid the loss of sales chance of their products. Therefore, formation of market that trade manufacturing capacities at appropriate price is needed.

Said manufacturing capacities include not only wafer processes but also other manufacturing processes such as packaging, testing, and reliability check processes.

It is an object of the present invention to provide methods to form markets to trade said manufacturing capacities which have technological categories (attribute) like semiconductor products.

Another object of the present invention is to guarantee reliability of traded said manufacturing capacities.

A further object of the present invention is to provide useful information for traders at markets.

A further object of the present invention is to provide methods to solve troubles on trading markets, and to provide the methods to form appropriate market prices using said trouble information.

A still further object of the present invention is to provide useful methods to stable operations for the industries which need huge investment.

### SUMMARY OF THE INVENTION

The present invention's trading methods are to trade manufacturing capacities using computer systems and computer networks, comprising the steps that the traders connect their computers to the trading site server and input screens are displayed on the monitors, the step that the traders input the code information associated with manufacturing capacities and sell and/or buy actions and trading prices and trading sizes and trading due/periods to input screens and that said code information are sent to the servers and the sent information are stored in the trade information files as trading information, the step that the servers judge the codes associated with trading information such as attributes of manufacturing capacities and sell and/or buy actions and trading prices and trading sizes and trading due/periods between trades, to make trade matches.

The present invention's trading systems are the trading systems which trade manufacturing capacities using computer systems and computer networks, comprising the means that the traders connect their computers to the trading site server and input screens are displayed on the monitors, the means that the traders input the code information associated with manufacturing capacities and sell and/or buy actions and trading prices and trading sizes and trading due/periods to input screens and that said code information are sent to the servers, the means that the sent information are stored in the trade information files as trading information, the means that the servers judge the codes associated with trading information such as attributes of manufacturing capacities and sell and/or buy actions and trading prices and trading sizes and trading due/periods between trades, the means to make trade matches between trades.

Therefore, the plants and manufacturing outsourcers outsourcing their product manufacturing to these plants who want to participate or use the present invention's trading systems, register their security information to said systems beforehand to keep secure connections to the systems such as VPN and SSL. The manufacturing capacities of certain plants on certain periods which manufacture the same kind of products are traded on said trading systems.

According to said trading system, traders can trade manufacturing capacities (left over manufacturing capacities). With these trades, seller of manufacturing capacities can avoid the left over of manufacturing capacities and keep manufacturing facilities at high operation rates. On the other hand, the buyer can buy left over manufacturing capacities at the reasonable prices. Through these trades, regardless up and down of production demand, plants can keep stable operations and manufacturing outsourcers can avoid losses of chances to sell their products by buying manufacturing capacities appropriately. The present invention uses computer systems and computer networks, so there is no limit on place and time and fast transactions are possible.

Three configurations are possible to made trades. The first configuration is that trader offers later can select one of listed trade information which passed said judge processes. The second, that the sever computer program selects the most favorable offer from said listed trade information automatically. The third, that a trade is made between traders which offer a pair of trade information provide, if there is only pair of trade information which passed said judge processes.

Said manufacturing capacity attribute information can include product types which can be manufactured by this manufacturing capacity and the yield information of this manufacturing capacity. The present invention is not only the trades of manufacturing capacities, but also the trades of manufacturing capacities categorized by said manufacturing capacity attribute information. Thus, in case of the trades categorized by said manufacturing capacity attribute information, said manufacturing capacity attribute information act as important conditions which decide trade makes, more efficient trades are possible using computer systems (servers) in the trades made on the present invention's computer systems and computer networks.

In case that yield of the product doesn't reach the yield included in said manufacturing capacity attribute information when the product is manufactured by the traded manufacturing capacity, a penalty calculated along a certain standard can be posed to the seller of the trade. These penalties can make trade reliability higher.

Said server computers allow certain traders to trade more manufacturing capacities than they really have. These traders are examined beforehand, and theses traders' credibility information is registered in the files in the servers. In addition to this type of over capacity trade, trades can include right trades so that traders can trade rights to sell or buy manufacturing capacities at predetermined prices on predetermined dates. These future and option trades satisfy trading requirements of positively risk-taking and risk averse traders, and provide more various trades than when only forward trades are allowed, to contribute price and operation rates stability.

The present invention or said trading system are especially suitable for semiconductor wafer processes, semiconductor chip packaging processes, and semiconductor testing processes. Manufacturing capacity trades in which attributes of manufacturing capacities are important, like the present invention, are suitable for trades of semiconductor manufacturing capacities.

Said trading system or said trading method can select attributes of manufacturing capacities necessary to manufacture its products, by inputting the number of the product to manufacture, the specification of the product, and the design rules of the product, at traders request, and indicate code information of matched offers automatically. Providing these kind of useful information for trades, make the present invention trading system easy to use, and convenient for traders. In addition, this function make it possible for traders, for example users of semiconductor products, who don't know semiconductor technologies, to select appropriate foundry companies, to participate trades. In the other word, users of semiconductor products can simply select manufacturing capacities with the most appropriate attributes using said system's function, by inputting its product specification and so on, without knowledge of detail information to realize its product specification. With this function, users of semiconductor products can procure semiconductor products without helps of semiconductor manufacturing outsoucers such as design support companies.

Said trading system or said trading method can show the information of providers who provide IPs (Intellectual Property) and technological services such as design support services necessary to design the product at trader's request, by inputting its product specification, and the trader can procure IPs and services such as design support. Like said function, this function also make it possible for users of semiconductor products to participate said trades, and to provide users of semiconductor products with benefits.

Said trading system or said trading method has files which record trading situation. Said trading system or said trading method records quality troubles, delivery delays and other trouble factors in said trading record files, and indicate those price reduction factors numerically. Said trading system or said trading method also provides the services where the manufacturing capacities and services with those price reduction factors are traded at certain reduced prices according to said trading recording files. Thus, said trading system or said trading method can form appropriate prices fairly by feedbacking trouble information to trades.

In this statement, the Internet means, the computer networks which comprise multiple computers, or the worldwide level computer networks connected via telecommunication networks between the computers which are used standalone. In this statement, the Internet doesn't necessarily means use of certain telecommunication protocols such as TCP-IP, but also means global or closed network environments which telecommunicate between computers or computer networks using appropriate telecommunication protocols.

### BRIEF DESCRIPTION OF THE DRAWINGS

FIG. 1 is a conceptual diagram which shows an example of trade system of the invention.

FIG. 2 is a block diagram which shows an example of server computer system configurations used by trading service providers.

FIG. 3 is a flowchart which shows an example of trading methods in the invention

FIG. 4 is a diagram of display screen which shows an example of input screens of transaction information.

FIG. 5 is a diagram which shows an example attribution information lists of manufacturing capacities.

FIG. 6 is a diagram of display screen which shows an example of input screens of attribute information.

FIG. 7 is a diagram of display screen which shows an example of registration screens to input LSI attributes.

FIG. 8 is a flowchart which shows an example of processes to create the lists of plants which can provide manufacturing capacities.

FIG. 9 is a diagram of display screen which shows an example of ratings of to the past works of a technological service provider company.

### DETAILED DESCRIPTION OF THE INVENTION

Hereinaftere, the preferred embodiments are explained using the semiconductor industry as an example, where manufacturing outsourcing is developed most.

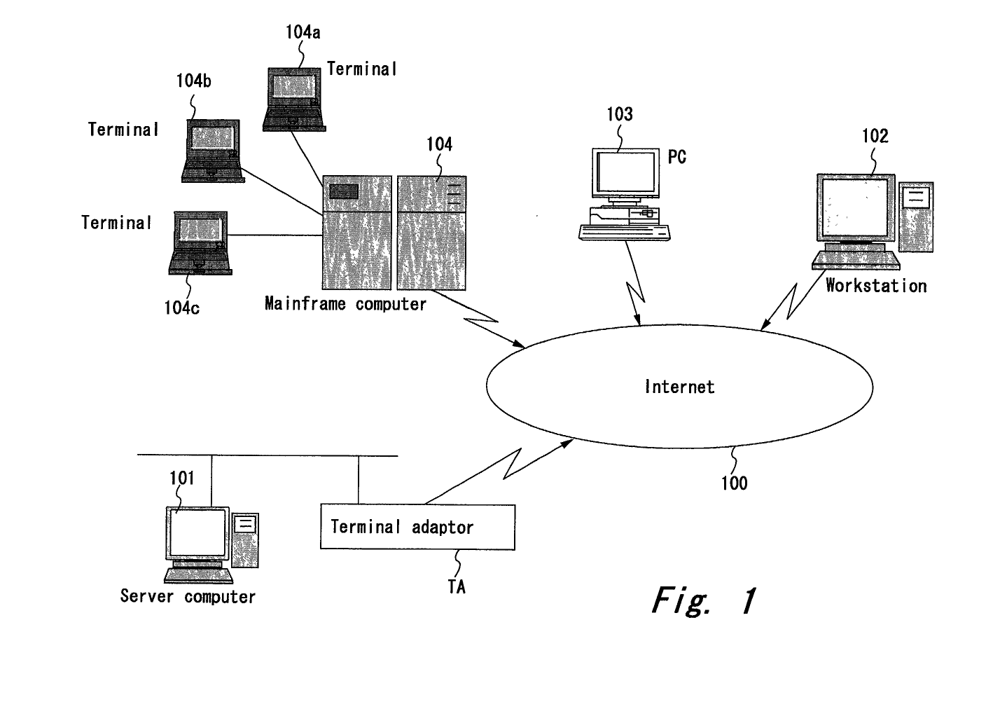

FIG. 1 is a conceptual diagram of an example of the invention. The trade system, that is embodiment of the invention, comprises Internet 100, the server computers 101, the workstations 102, the PCs 103, and the mainframe computers 104. The server computers 101, the workstations 102, the PCs 103. The mainframe computers 104 are information devices connected to Internet to exchange information, and can include other information devices such as PDAS, cellular phones, Internet televisions, and any kind of information terminals so on. In this embodiment, the server computers 101, the workstations 102, the PCs 103, and the mainframe computers 104 are used as examples of computer systems traders can use, but it is natural that other information devices can be used.

Terminal Adapters (TA) are connected to the server computers 101. Input and output of information are done through TAs. The workstations 102, the PCs 103, and the mainframe computers 104 except the server computers 101 are also connected to TAs similarly, but TAs are omitted in the FIG. 1. Data modulation demodulation devices like access point routers or Modems can be used instead of TAs. The example, in which the server computers 101 are used to explain this embodiment. However, it is obvious that other information transaction devices can be used instead of the sever computers 101.

The terminals 104a, 104b, and 104c are connected to the mainframe computer 104. In addition to these three terminals, more terminals can be added to the mainframe computer 104. The mainframe computer 104 may connected other networks through Internet gateway. Other networks includes commercial networks such as VPN, enterprise private networks and any kinds of networks which can be connected to Internet.

In this embodiment, the system which trades manufacturing capacities through Internet 100 as an example. Client sever systems comprised mainframe computers or workstations as server computers connected with private networks such as VPN or enterprise dedicated lines may be used instead of Internet 100. Therefore, computer networks comprise sole computer system (or client server system) and terminals. Traders can use terminals (or client systems), and trade service operators can use server computers to operate trading markets.

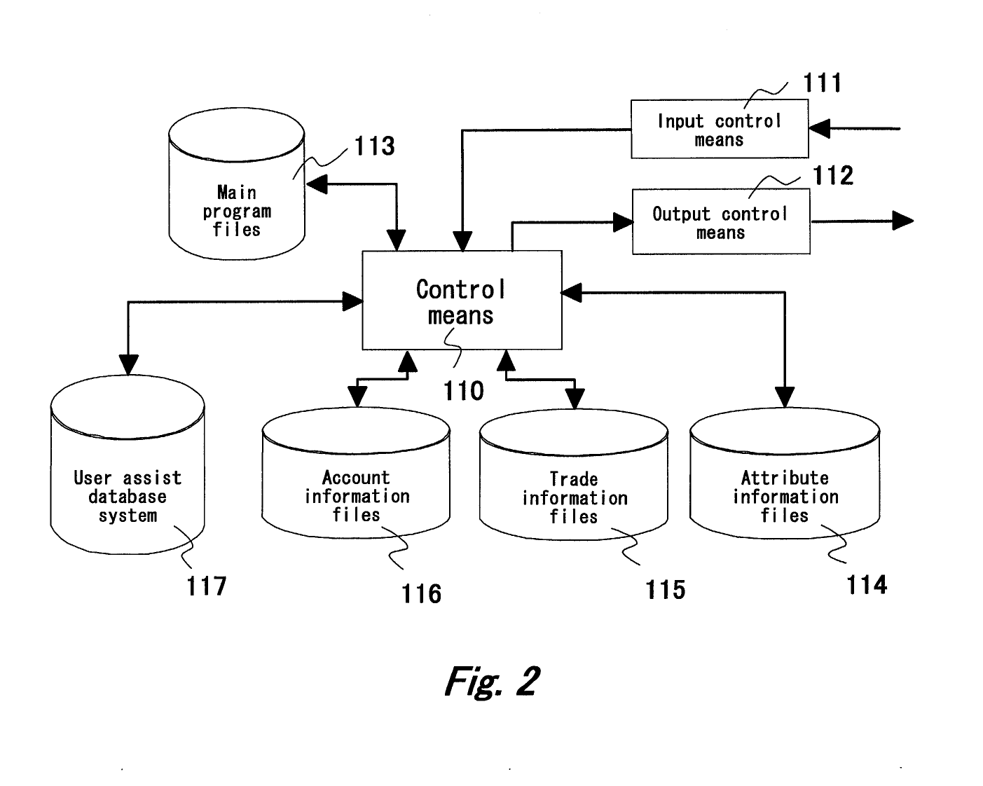

FIG. 2 is a block diagram which indicates one of the examples of system configurations of server computers 101. In this embodiment, server 101 comprises control means 110, input control means 111 connected to Internet 100, and output control means 112. Control means 110 transfers various kinds of binary data to files, and controls read in and send out of binary data into/from files through input control means 111 and output control means 112, and sends/receives information from/into Internet 100. Control means 110 transacts data transfer between files in other servers in the system 101 and data transaction such as data searches. Input control means 111 and output control means 112 are, for example, such as said TAs.

Server computer 101 stores the main program file 113, the attribute information files 114, the trade information files 115, the account information files 116, the user assist databese 117. These files may be stored in a one storage device or in physically divided multiple storage devices. In addition, each file may not be necessarily controlled directly by the control means 110, and may be controlled through other computers. Said each file is required to be controlled by the control means 110 not physically but logically. Then, Said each file is not necessary required to be stored in the same device or the physically same place.

The main program file 113 includes the program to control trading method in the embodiment. It includes the display program of many kinds of screens, the program to check registered parties' IDs and passwords, the program to store attribute information of manufacturing capacities, the search program, the program to control trade information and account information, the program to manage user assist databese, and so on. Detailed function explanation of these programs are described later.

The attribute files 114 records attribute information associated with manufacturing capacities traded in the markets. For example, in the semiconductor wafer processes, attribute information are process types such as CMOS or Bipolar, design rules which include critical feature sizes and isolation layer materials and metal materials and plug materials and metal line pitches and the number of metal layers and the number of maximum transistors integrated on a die etc., device parameters which include transistor thresholds and switching delays and supply power voltages, wafer sizes, the number of wafers in a lot, maximum die sizes, average and estimated yields, average and maximum turn around times, the number of average and maximum wafers processed in a month, and so on.

The trade information files 115 records trade information offered along with the trading methods described later. The computer system of the embodiment makes successful trades referring these trade information files under the control of the main program automatically. The account information files 116 records these accounting information related to money transactions of these trades. These trade information files and account information can be used for credibility checks not only observing whether normal trades are done or not.

The user assist databese 117 stores data, to indicate appropriate and necessary attributes of manufacturing capacities, and to indicate necessary intellectual properties and service providers which provide necessary assistance to design the circuits. These user assistance functions make it possible for the traders who don't have enough knowledge to handle these attribute information, for example the semiconductor users, to use this trading system.

Although the computers 101 include input devices such as key boards and mice and output devices such as CRTs or liquid crystal displays, explanation of these devices are omitted.

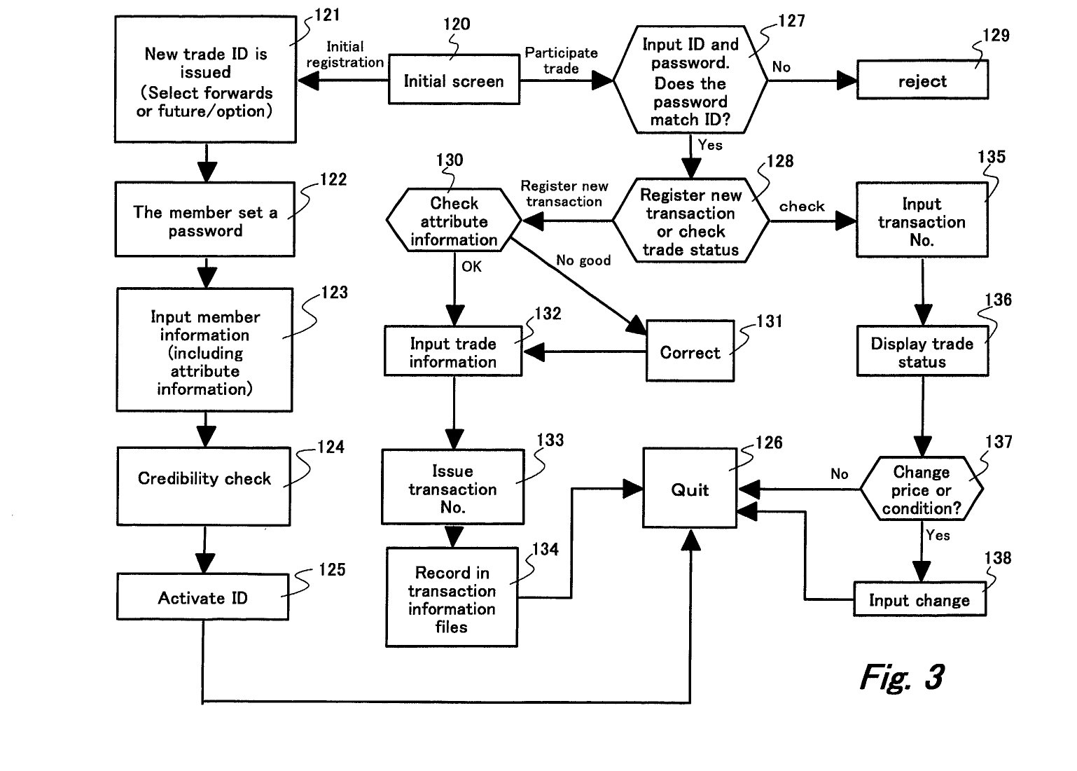

FIG. 3 illustrates the flowchart which show an example of trading methods of the invention. The trading methods of the embodiment begin with display of initial screens (the step 120). The initial screens are displayed on the output devices of the workstations 102 etc. The accesses to the initial screens are done by accessing the server computers of trade service providers with input of appropriate URLs to ordinary WWW browsers. In this case, the initial screens are described in HTML or other appropriate WWW description languages. In this embodiment, the case that homepages, which can be displayed ordinary WWW browsers, and which are described with the languages (such as HTML) displayed by these ordinary WWW browsers, is used as an example. However, means to display screens are not limited to the case, may be any languages and any display programs which fit to display homepages described along with any protocols or formats. The means to display other screens are treated like initial screens.

There is a trade participation menu on the initial screen. Those who participate the trade for the first time, register themselves. When the initial registration menu is selected, the initial registration screen is displayed, and the buttons to select “forwards”, “futures” or “options” are displayed on the initial registration screen. “Forwards” are the trades to trade some parties' part of real manufacturing capacities in the future within its all the capacity. “Futures” are the trades to trade some parties' part of real or virtual manufacturing capacities in the future beyond its all the capacity. “Options” are trades to trade the rights to sell or buy some parties' part of real or virtual manufacturing capacities in the future. Which trades to select affects necessary credibility or deposits to participate. For example, to participate future trades more credibility or deposits are required.

In the initial screen, new ID codes for “forward” trades are issued to those who select “forwards” button, new ID codes for “future” trades are issued to those who select “futures” button, so as “options” (the step 121).

In next step, those who start trades, set passwords to each trades (the step 122). The passwords are set freely and can be changed later by those who start trades.

In next step, those who start trades, input their membership numbers, company names, and company registration information so on (the step 123). Said computer system check information from credibility point of view (the step 124). Said computer system activates the new IDs, if there is no problem (the step 125). Then, those who start trades, exit from said computer system (the step 126). Those who start trades, can participate trade market by activation of their IDs.

Those who have activated IDs, can participate the trade market by registration of their transactions (bids) in said computer system. They select participation menu in the initial screen, and go to the next screen. Then, they input their activated IDs and corresponding passwords. Said computer system checks each ID and password (the step 127), goes to the next step 128 if password corresponds to each ID, and goes to the step 129 if password doesn't correspond to each ID.

In the step 128, they select new transaction (bid) registration menu or trade status check menu (the step 128). A new transaction (bid) is registered by selecting type of trades, “selling” or “buying”. Trade status check is made by selecting “status check” button.

Hereinafter, the case that a manufacturing capacity of a plant is sold (“selling”) is explained as an example. Those who want to sell the manufacturing capacities of their plant select “selling” menu, then they check the attribute information of their plants in the next screen. They go to correct screen and correct their information registered beforehand (the step 131). They go to transaction (bid) registration step, if their information are correct (the step 132).

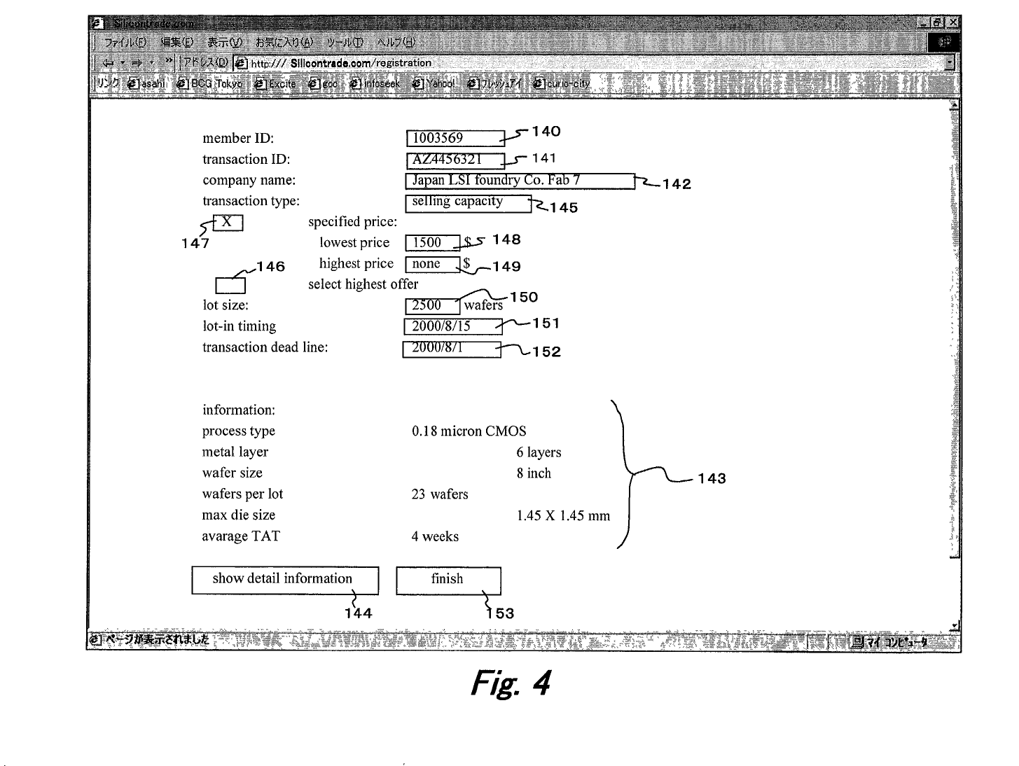

FIG. 4 is an example of the transaction input screen. The “member ID” displayed the field 140 is the ID issued to each manufacturing capacity. The member IDs are different even for the same trader, if their attribute information are different. The “transaction ID” in the field 141 is the unique ID issued to each individual transaction (bid), and used to check the status of each transaction (bid). The company name of the trader is displayed in the field 142. The information for trader's check purpose (“1.8 micron CMOS process” is displayed here) is displayed in the field 143 of said screen. The information in the field 143 is a part of the information of initial registration. The “detail information” button 144 is selected to display detail information when confirmation of detail information is necessary.

The button, “selling capacity” or “buying capacity” in the field 145, “transaction type” field, is selected when a transaction (bid) is registered. Hereinafter, the case that “selling capacity” is selected is shown as an example.

The “price at the market” or the “specified price as lower limit or upper limit or both” is selected as a way to specify the trade price. In this embodiment, two ways are shown as an example, of course, other ways can be used to trade. In case that The “price at the market” way is selected, a check mark “x” is input in the field 146. In case that the “specified price” way is selected, a check mark “x” is input in the field 147. In this example, to specify US$ 1,500 as a specified price as lower limit, “1,500” is input in the field 148, and “none” is input in the field 149.

The manufacturing capacity to trade is input in the next step. “Selling capacity” is selected in this case, and the amount and timing information of the manufacturing capacity are input. For example, the number of wafers (2,500 is input in this example screen) in the field 150, “lot-in timing” in the field 151 and “transaction dead line” in the field 152 are input respectively. “lot-in timing” is the timing to input said lot into the manufacturing capacity, and “transaction dead line” is a deadline to make the trade in advance to “lot-in timing” in order to prepare necessary information and works to input said lot into the manufacturing capacity. Aug. 15, 2000 and Aug. 1, 2000 are specified respectively. After input to all the necessary fields is done, the “finish” button 153 is selected and input of the transaction is finished.

Next, the system issues a transaction (bid) number to the input transaction (the step 133), records the transaction (bid) into the trade information files 115 as transaction databases (the step 134). Then, registration of a new transaction is over.

The trade system in the embodiment, selling orders, registered like this, are bought by those who input highest prices to each selling order, in case of the price at market way. Selling orders registered are bought by those who input the specified prices to each selling order in case of the specified price way. If there are several buyers who meet the conditions exist in case of specified price at way, sellers can select one of buyers at sellers' choices.

In case that the transaction status check menu is selected in the step 128, they go to Step 135, and input transaction numbers (the step 135). The system check the transaction status of each transaction, and show the status (the step 136). If the trade of the transaction isn't successful yet, change of the price or other conditions can be selected (the step 137). When the change of the conditions is selected, changed conditions are input (the step 138). The change input screen is similar to FIG. 4. If no change is made, they exit from the system.

In case that “buying capacity” is selected in the step 128, the work is similar to the “selling capacity”.

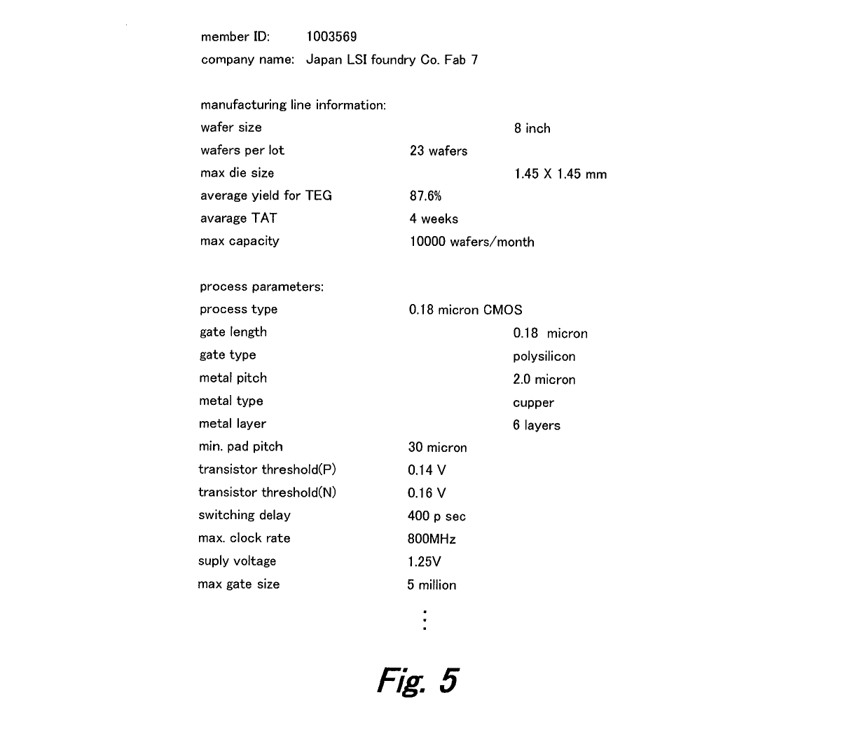

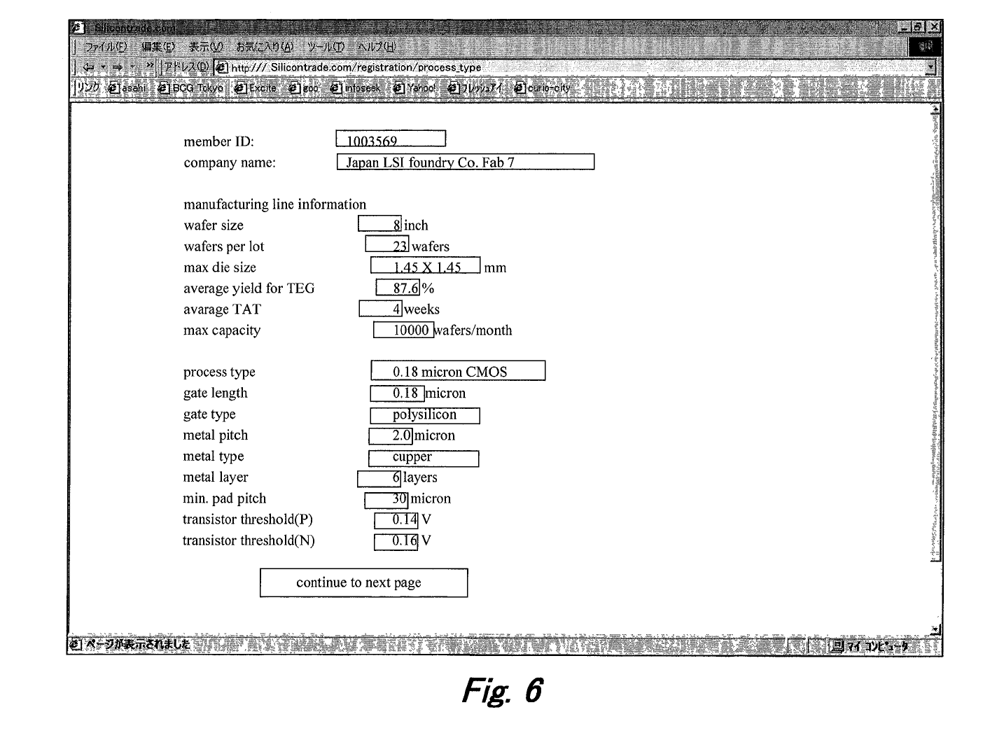

FIG. 5 is a diagram which illustrates the list of said manufacturing capacity attribute information, and FIG. 6 is an example of input screen of attribute information. The input of attribute information is done in the member information input step (the step 123) of the new member registration phase, the attribute information can be changed at the transaction registration step (the step 131).

In general, manufacturing capacities of plants are various, can't be sold or bought simply like financial products. For example, in case of semiconductor industry, there are many different 0.18 micron process technologies, of which the pitches and the number of layers of metal lines, transistor device parameters are different by each manufacturer even or by each line of a plant. The system make a group of transactions (bids) which are compatible to some extent by the lists of attribute information, and make successful trades among them. The judge of compatibility is done by the program installed in the system automatically. The explanation of judge criteria of compatibility of attribute information is omitted because it can be designed by technological common sense at that time.

The new trade environment hereinafter is provided by the trade system of trading method in the embodiment. For example, manufacturing capacity of a semiconductor plant is used to explain the new trade environment. If 20% of manufacturing capacity of said plant in the month four month ahead is expected excess its demand, the plant can sell excess capacity on the trade system by specifying types of semiconductor products which can be manufactured by the plant. For example, detail information such as 0.18 micron, six metal layers, and CMOS logic process, and so on like FIG. 5. If there are companies, which are lack of manufacturing capacity in the month four month ahead, and if one of them make an offer, a successful trade is made using said trade system. Trades are made fast though Internet or similar appropriate data communication methods. On the other hand, if 30% of manufacturing capacity of said plant six month ahead is expected to be short, a necessary amount can be bought through said system of this embodiment. Trades can be done at the unit of a month from one month ahead to a year ahead, or at short time units, or for longer terms. Hereinafter, trades are supposed to be done at the unit of a month from one month ahead to a year ahead. Said plant can sell manufacturing capacity now four month ahead, or sell it one month later as a trade three month ahead after checking production schedule examined more precisely.

Said system in the embodiment make it possible to trade short period and/or small amounts of said excess manufacturing capacities. For example, in case of semiconductor manufacturing capacities, trades of a month and/or 100 wafers is possible. In general, it is common to make long term manufacturing outsourcing contracts such as a year or two years. However, it is difficult to guarantee outsourced manufacturing amounts for long terms. Then, usually both sides of a long term contract decide rough or average amounts of manufacturing capacities outsourced in the contract, the manufacturing outsourcer side on the contract notices the exact amount of manufacturing capacity outsourced to the plant side of the contract, just before the next month. In the manufacturing outsourcing ways like this, the outsourced plant can't fix manufacturing schedule just before the next month, that means it is very difficult for the outsourced plants to keep stable and high operation rates. On the other hand, the outsourcing side can't increase (or sometimes even keep) amount of manufacturing capacity in the next month, because the outsourcing side doesn't keep exact amount of manufacturing capacity of each month certainly under this kind of contracts. Nevertheless, it is difficult that outsourcing side make precise manufacturing schedule in the future, and guarantee exact amount of manufacturing capacities to the outsourced plant under the long term contracts. However, if they use the trade system in the embodiment, both side have merits, because both sides trade excess or shortage amount of manufacturing capacities. In addition, the trade system in this embodiment can raise the operation rates of plants under the ordinary long term contracts. Manufacturing outsourcers can guarantee exact amount of outsourcing manufacturing capacities to outsourced plants in long term contracts. If there are excess of manufacturing capacities just before, they can sell manufacturing capacities though the trade system in the embodiment. On the other hand, If there are shortage of manufacturing capacities just before, they can buy manufacturing capacities though the trade system in the embodiment. The trade system in the embodiment can trade even small amount of lots, and adjust the operation rates of plants world wide using market mechanism, because the trade system can connect many similar plants and manufacturing outsoucers world wide. The mechanism like this can feedback of demand prediction of user sides, and keep appropriate supply demand balance, and form appropriate market prices which is necessary to sound growth of industries.

The trade system in the embodiment can keep stable operation rates of plants. The trade system in the embodiment can provide not only manufacturers but also users of these products as parts, with merits. For example of the semiconductor industry, the user of semiconductor products (such as LSIs) as parts can manage manufacturing these parts as well as keep parts securely in the future, by participating the trade for itself directly. This user's direct participation to the trades makes total cost cuts possible by reducing stocks of parts and final products. Especially, in recent years, the importance of SCM (Supply Chain Management) is recognized widely. Much better results are possible than SCM by final product manufacturers' exact manufacturing management of parts like LSIs. Good results like this can be expected by introducing the trade system in the embodiment.

Hereinabove, the trade system in the embodiment is explained. However, the system can be changed as long as it strays within the outlines of the invention. Hereinafter, other embodiments of this invented concept are explained.

For example, the manufacturing outsourcers, which want to buy manufacturing capacities, and plants, which want to sell manufacturing capacities, can set limit to prevent their specific competitors from seeing offered prices in the trade system in other embodiment.

In the trade system in the other embodiment, price premiums can be set to the buyers, who require hard conditions such as shorter turn around time or excess quality controls, or sellers who provide bad manufacturing outsourcing services such as often delivery delays, to take these orders at appropriate prices than the other normal orders. In order to this, the trade information of each member of the trade system is recorded in database systems. The example of the contents of the information would be probabilities of quality troubles, the extent of each trouble, and the frequency of delivery delays for the plant which provide manufacturing capacities. These information is expressed in numbers in some ways such as average or score boarding etc. The importance of these troubles such as delivery delays, quality problem and so on differs by each manufacturing outsourcer. Negative premiums are calculated by multiplying each certain coefficient which is different by manufacturing outsourcer, to each trouble information of each plant expressed in numbers. These negative premiums are added to the bidding prices to adjust the balance of price and quality of each bid. By this means, the plants, which provide better quality and more precise product delivery, can be selected at appropriate price. In this case, a plant side example is used to explain, but similar approach can be applied to manufacturing outsourcers.

Semiconductor wafer processes are used to plain said embodiment, but similar trades can be made in semiconductor packaging and testing processes as other embodiments. In addition, similar trades can be made in other industries such as electronics products, steel, so on.

In other embodiment, said trade service provider can do spot buys of excess manufacturing capacities at the price set beforehand, and manufacture certain products which are decided to be manufactured beforehand, in case that no successful trade is made because there are no buyer for some sell bids. Normally manufacture on order system is taken in semiconductor industry. No semiconductor products except wide purpose products like DRAMs and FPGAs are made without order. On contrary, there is a little dead stock risk to manufacture wide purpose products with excess manufacturing capacities bought at low prices, because these products are manufactured at low costs, and can be sold at low prices. Therefore, the operation rates of plants can be kept at a high level, and the industry efficiency can be raised, and provide products at lower prices.

Said trade system doesn't trade finished products but manufacturing capacities. Therefore, there is a possibility that yields in real mass production of finished products may be differ a lot from the expected yields. In other embodiment to cope with this problem, the attribution information files can include the yield data of standard test patterns or standard test products which are manufactured experimentally to measure and compare each plant manufacturing capability. The yield of a product the buyer wants to manufacture using a manufacturing capacity, can be calculated beforehand at a certain level of accuracy based on these yield data. In case that a real yield of the product using the manufacturing capacity is lower than the lower limit of yield calculated beforehand, the buyer can require a penalty to the seller of the manufacturing capacity. This means raises safety of trades and reliability of the trade system of the embodiment.

Said trade system can trade even excesses and shortages of small lots, and adjust operation rates of plants world wide with the market mechanism, by connecting the same kind of plants and the same kind of manufacturing outsourcers though Internet. Nevertheless, operation rates go up all together in boom times and a lot of excess of facilities come out in depression times, in scale industries which require huge machines and facilities, represented by semiconductor. Therefore, long term adjustment mechanisms are needed. To satisfy this requirement, in addition to said forward trades, future trades are introduced in other embodiment. Said forward trades are to trade real manufacturing capacities at some times in the future, must be correspond each real existing services, which are manufacturing capacities of real plants. On contrary, future trades, like financial products, make long term prediction of demands and needs more precise in other embodiment. This more precise prediction of future markets make positive feedback to facility investment plans of plant sides. In the other word, this mechanism divides manufacturing parts of industries into risk parts and risk-free parts, lets pure investors and brokers take risk parts, and can realize sound development of each industry by reducing risks of real manufacturers. The difference between financial future markets and the market in the embodiment is that manufacturing capacities are divided into many groups by the attribution information and traded with the groups, and that pricing is complex, because attribution coefficients are different by each buyer. Hereinafter, the trade system of the other embodiment are explained using the flowchart on FIG. 3. The trades of the other embodiment are done on the same computer system as said computer system. Those who begin to participate the trades do initial registrations by selecting the initial registration menu. After the initial registration menu is selected, the initial registration screen is displayed, the buttons to select forwards or futures/options are display on the screen. If the future/option button is selected, future/option trade IDs are issued to said initial registrants. Next, said initial registrants set passwords corresponding to each ID. The steps after the IDs are activated are similar to those of said forward trades. However, trades are made, if prices of sellers and buyers are matched, even if there are no real manufacturing capacities corresponding to each transaction.

In other embodiment, in addition to said future trade, options such as puts, calls, other options, and combinations of them, provide plants and manufacturing outsoucers for the risk hedge mechanisms. For example, substitutes offering insurance can be realized using these options. There is a possibility that yields of finished products may be differ a lot from the expected yields in real mass production in said trade system. It isn't a solution of the problems for the manufacturing outsoucers which order manufacturing outsourcing, to receive penalties, in case that the actual yields are smaller than the expected. It is important for them to supply shorted amounts of products as soon as possible. Some manufacturing outsoucers keep right to use manufacturing capacities of some or certain plans for backup purpose, by buying call options, assuming that the case above or other unpredictable happenings such as earthquakes, in the other embodiment. Of course, they pay option premiums for those options. The option premiums they paid are thought as substitute offering insurance charges, when they don't use option rights.

In other embodiment, it is possible to provide risk ratings by calculating expected values that a real yield is less than the average yield of each plant. Each manufacturing outsourcer can buy options by calculating the necessary volume of options using the risk ratings. The option premiums are decided according to the risk ratings and expected market prices at that time. The sellers of call options must take manufacturing outsourcing of call option buyers on right fulfillment. On the other hand, the seller can receive option premiums without manufacturing outsourcing, when no right fulfillment occurs. The means to participate option trades is similar to said trade system, which begin to get option trade IDs. In addition, it is possible to develop derivative products by combining these options like financial markets.

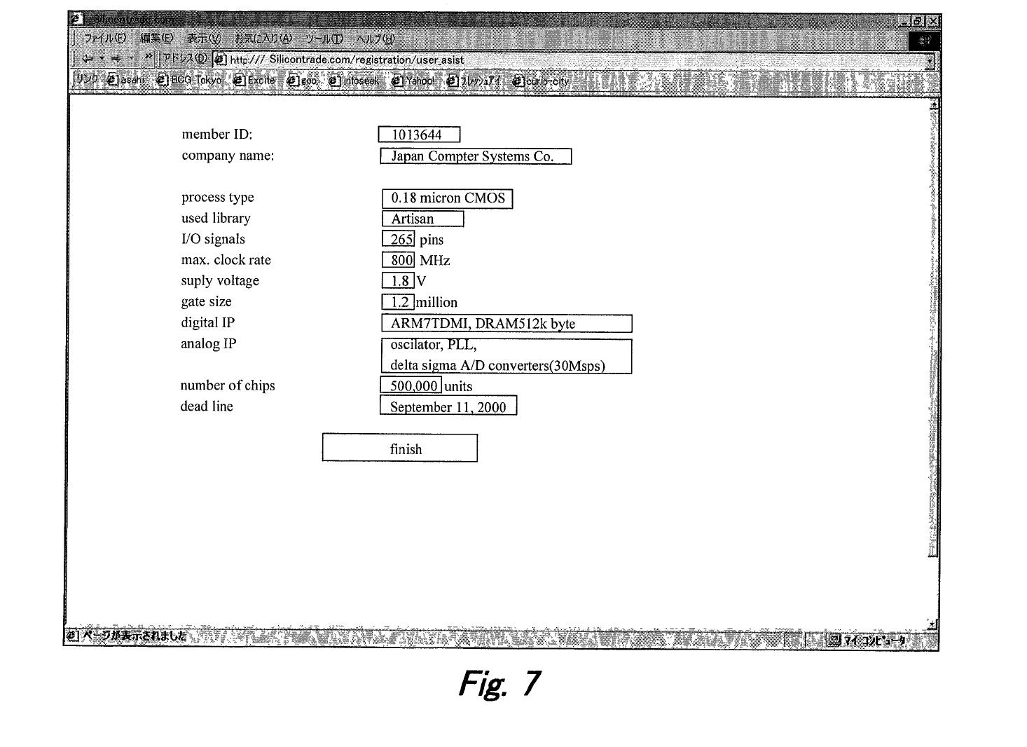

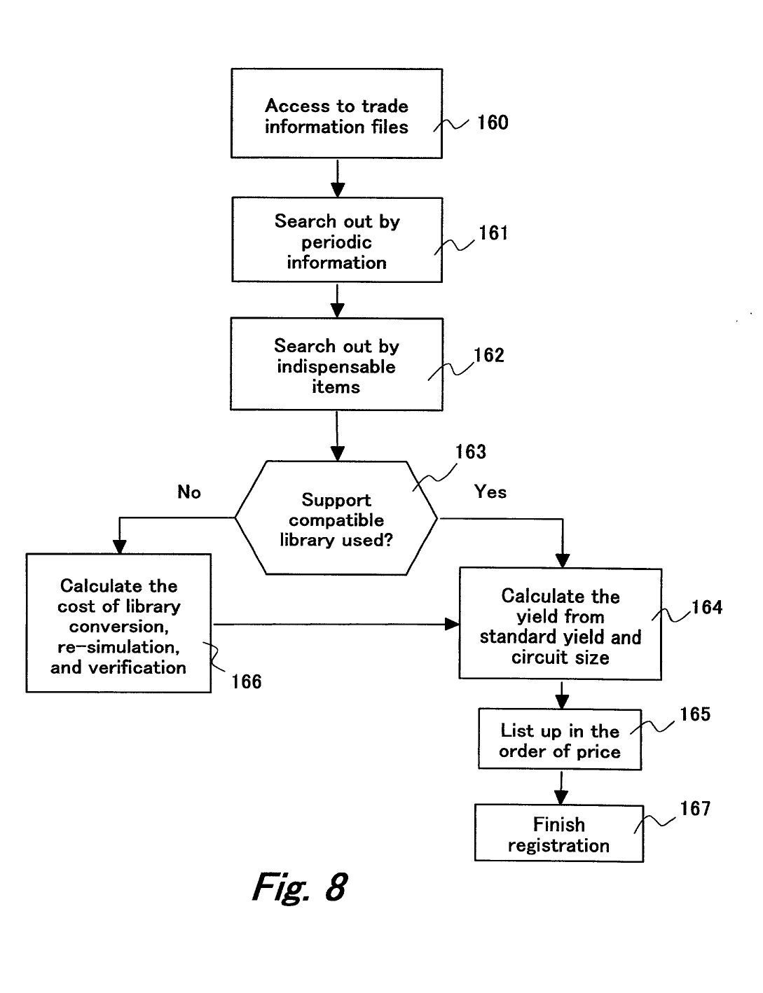

In other embodiment, the computer system to assist trade participation using rule base systems. Those who aren't familiar with the industries can participate trades with this system. For example of semiconductor industry, the system can automatically calculate the necessary process technologies and manufacturing capacities to each trader who isn't familiar with semiconductor industry, for example, a semiconductor user who uses semiconductor devices in its final products, using the rule base systems. Each user can participate the trades directly with this system. The users are thought to participate trades, because these trades have merits for users of what these plants manufacture. The users can predict the number of semiconductor parts they need, but it is difficult for them to judge appropriate manufacturing plants and calculate necessary manufacturing capacities to manufacture these semiconductor parts. The system, which can advise appropriate manufacturing plants and calculate necessary manufacturing capacities, from the input data such as the specifications and the number of semiconductor parts the users need, is needed. Especially, the system is important for the system LSIs. FIG. 7 shows an example of registration screens for users to input the attribute information of LSIs the users need. The type of manufacturing process, the library used, the number of necessary I/Os, maximum clock frequency, the number of transistors, necessary IPs, mixed signal capability, and etc. are input. The list of plants, which can provide manufacturing capacities is generated to said registration as the flowchart shown in FIG. 8. First, the system accesses said trade information files 115 (the step 160), and extracts transactions matched to the periods said user needs by searching out said files (the step 161). Then, the system cut down candidate transactions (bids) by indispensable items among the attribute information of the LSI the user needs (the step 162). Here, indispensable items could be the number of necessary I/Os, maximum clock frequency, the number of transistors, necessary IPs, mixed signal capability, and so on. The list is divided into two groups (the step 163). the one which can use the same library of the same process as the one used to design the LSI, the other which can't use it. For the first group, the system calculate estimated yields using standard yield data of said attribute information files and said LSI attribute information such as the number of transistors, and IPs used (the step 164). The system estimate prices of the LSI manufactured by each manufactured capacity from each bidding price and estimated yield, and list them up in the order of price (the step 165). For the second group, the system calculates necessary man power to convert library of the circuit of the LSI into the library available, because the same library can't be used for the second group and library conversion, re-simulation and reverification are needed (the step 166). The system convert the man power to a cost, and add it to the final LSI prices, and list them up in the order of price in the similar way to the way for the first group (the step 165). The user checks the list and registers list by selecting “register button” if there is no problem (the step 167). By this means, those who aren't familiar with the industry, for example semiconductor industry, can participate the trades in the system. It is possible to get advertisement charges by showing advertises of companies which provide related necessary services such as design support services and library conversion services on the screens of the trade system of the embodiment.

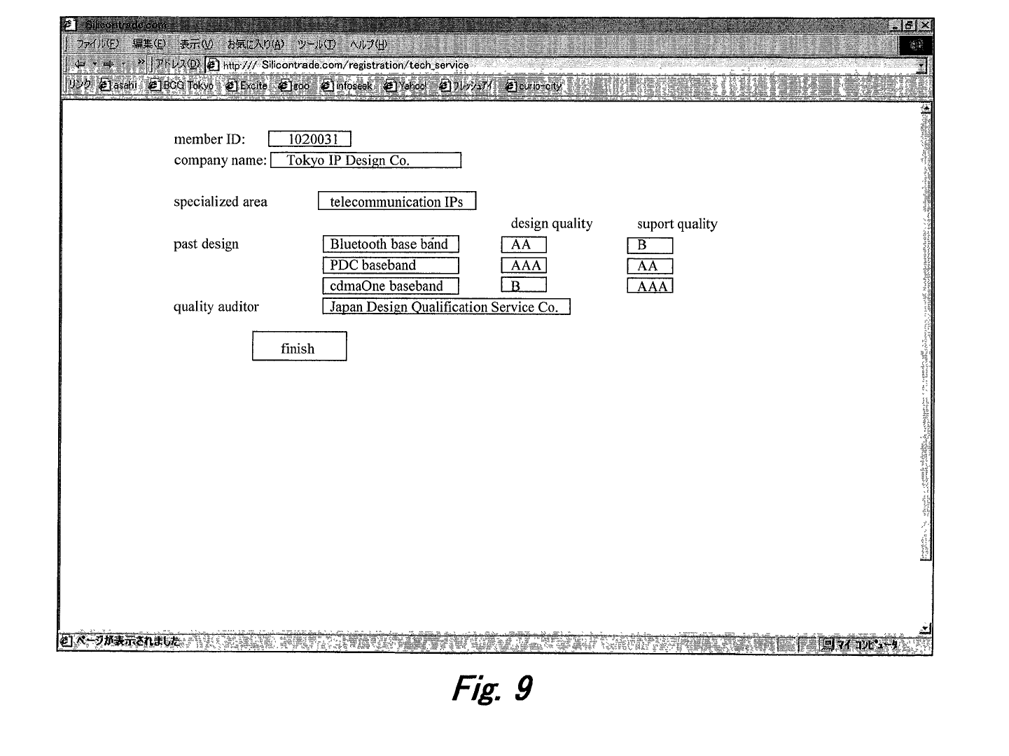

In other embodiment, not only trading manufacturing capacities but also trading or indicating IP (Intellectual Property) development capabilities and appropriate design support capabilities the users need, according to the certain rules. On this system, the users can procure said IPs, IP development capabilities and appropriate design support capabilities by competitive bidding. As integration size of semiconductor products is becoming larger, it is becoming more indispensable to procure the circuits integrated on semiconductor products like IPs and technological supports from outside. In this embodiment, the means is provided to trade not only designed and verified IPs but also these technological services at fair prices with appropriate premiums according to the attributes such as each its service quality. The technological service company, which want to participate this trade, take third party rating company's inspections to its technological services the technological service company provided in the past beforehand. The rating company provides each technological service company with ratings to its quality of the circuit it designed and the technological services it provided, with cooperating of technological service company's users, by inspecting technological service company's past works. The rating company is not necessarily one, can be two or more, and can be selected by users. FIG. 9 shows an example of ratings to past works of each company. The rating data like ones shown in FIG. 9 can be recorded as attribute data. Also, theses data of a company can be divided and be recorded by each specialty area. For example, averages of past rating scores multiplied by some coefficient depending on each users, are used as price premiums. Trades in each specialty area can be done using these price premiums. Like

What is claimed is:

1. A method for trading a manufacturing capacity using computer system(s) and computer network(s), comprising the steps of:
connecting to a trading site server;
displaying an input screen on a monitor of the trader's computer;
inputting code information associated with the manufacturing capacity and sell and/or buy actions and trading prices and trading sizes and trading due/periods to the input screens by the trader;
sending the inputted information to the trading site server;
storing the sent information in trade information files of the trading site server as trading information;
looking up the trading information in the trade information files; and
judging the codes associated with trading information such as attributes of manufacturing capacities and sell and/or buy actions and trading prices and trading sizes and trading due/periods between trades, to make trade matches.

2. The method according to claim 1, wherein the configuration to made trades is that trader who offers later can select one of listed trade information which passed said judge processes.

3. The method according to claim 1, wherein the configuration to made trades is that the sever computer program selects the most favorable offer from said listed trade information automatically.

4. The method according to claim 1, wherein the configuration to made trades is that a trade is made between traders which offer a pair of trade information provide, if there is only pair of trade information which passed said judge processes.

5. The method according to claim 1, wherein said manufacturing capacity attribute information can include product types which can be manufactured by this manufacturing capacity and the yield information of this manufacturing capacity.

6. The method according to claim 5, wherein a penalty calculated along a certain standard can be posed to the seller of the trade, in case that yield of the product doesn't reach the yield included in said manufacturing capacity attribute information when the product is manufactured by the traded manufacturing capacity.

7. The method according to claim 1, wherein the server includes register files that records pre-examined traders' credibility information, and
server computer allow the traders who registered in the register file to trade more manufacturing capacities than they really have.

8. The method according to claim 1, wherein the trades include right trade which trade rights to sell or buy manufacturing capacities at predetermined prices on predetermined dates.

9. The method according to claim 1, wherein the manufacturing capacities are semiconductor wafer process capacities, semiconductor chip packaging process capacities, or semiconductor testing process capacities.

10. The method according to claim 9, further comprising:
selecting attributes of manufacturing capacities necessary to manufacture its products, by inputting the number of the product to manufacture, the specification of the product, and the design rules of the product, at traders request; and
indicating the code information of matched offers automatically.

11. The method according to claim 9, further comprising:
showing the information of providers who provide IPs (Intellectual Property) and technological services such as design support services necessary to design the product at trader's request, by inputting its product specification; and
procuring the IPs and services such as design support.

12. The method according to claim 1, further comprising:
recording trading situation to trading record files;
recording quality troubles, delivery delays and other trouble factors in said trading record files, and indicating those price reduction factors numerically; and
providing the services where the manufacturing capacities and services with those price reduction factors are traded at certain reduced prices according to said trading recording files.

13. A manufacturing capacity trading system using computer system(s) and computer network(s), comprising:
a unit of connecting to a trading site server;
a unit of displaying an input screen on a monitor of the trader's computer;
a unit of inputting code information associated with the manufacturing capacity and sell and/or buy actions and trading prices and trading sizes and trading due/periods to the input screens by the trader;
a unit of sending the inputted information to the trading site server;
a unit of storing the sent information in trade information files of the trading site server as trading information;
a unit of looking up the trading information in the trade information files; and
a unit of judging the codes associated with trading information such as attributes of manufacturing capacities and sell and/or buy actions and trading prices and trading sizes and trading due/periods between trades, to make trade matches.

14. The system according to claim 13, wherein the configuration to made trades is that trader who offers later can select one of listed trade information which passed said judge processes.

15. The system according to claim 13, wherein the configuration to made trades is that the sever computer program selects the most favorable offer from said listed trade information automatically.

16. The system according to claim 13, wherein the configuration to made trades is that a trade is made between traders which offer a pair of trade information provide, if there is only pair of trade information which passed said judge processes.

17. The system according to claim 13, wherein said manufacturing capacity attribute information can include product types which can be manufactured by this manufacturing capacity and the yield information of this manufacturing capacity.

18. The system according to claim 17, wherein a penalty calculated along a certain standard can be posed to the seller of the trade, in case that yield of the product doesn't reach the yield included in said manufacturing capacity attribute information when the product is manufactured by the traded manufacturing capacity.

19. The system according to claim 13, wherein the server includes register files that records pre-examined traders' credibility information, and
server computer allow the traders who registered in the register file to trade more manufacturing capacities than they really have.

20. The system according to claim 13, wherein the trades include right trade which trade rights to sell or buy manufacturing capacities at predetermined prices on predetermined dates.

21. The system according to claim 13, wherein the manufacturing capacities are semiconductor wafer process capacities, semiconductor chip packaging process capacities, or semiconductor testing process capacities.

22. The system according to claim 21, further comprising:
a unit of selecting attributes of manufacturing capacities necessary to manufacture its products, by inputting the number of the product to manufacture, the specification of the product, and the design rules of the product, at traders request; and
a unit of indicating the code information of matched offers automatically.

23. The system according to claim 21, further comprising:
a unit of showing the information of providers who provide IPs (Intellectual Property) and technological services such as design support services necessary to design the product at trader's request, by inputting its product specification; and
a unit of procuring the IPs and services such as design support.

24. The system according to claim 13, further comprising:
a unit of recording trading situation to trading record files;
a unit of recording quality troubles, delivery delays and other trouble factors in said trading record files, and indicating those price reduction factors numerically; and
a unit of providing the services where the manufacturing capacities and services with those price reduction factors are traded at certain reduced prices according to said trading recording files.
